(19) United States
(12) Patent Application Publication
(10) Pub. No.: US 2023/0087262 A1
(43) Pub. Date: Mar. 23, 2023

(54) CONTROL STATION, WIRELESS COMMUNICATION SYSTEM, COMMUNICATION CONTROL METHOD, AND COMMUNICATION CONTROL PROGRAM

(71) Applicant: NIPPON TELEGRAPH AND TELEPHONE CORPORATION, Tokyo (JP)

(72) Inventors: Toshiro NAKAHIRA, Musashino-shi, Tokyo (JP); Hirantha ABEYSEKERA, Musashino-shi, Tokyo (JP); Koichi ISHIHARA, Musashino-shi, Tokyo (JP); Takatsune MORIYAMA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 17/911,369

(22) PCT Filed: Mar. 17, 2020
(86) PCT No.: PCT/JP2020/011781

§ 371 Date: Sep. 13, 2022

(51) Int. Cl. H04W 28/02; H04W 28/24; H04W 40/02

(52) U.S. Cl. CPC H04W 28/0268; H04W 28/24; H04W 40/02

(57) ABSTRACT

There are provided a collection unit that collects priority information indicating priority of radio communication set for each base station and route information for specifying a wired communication route for each base station, a radio parameter calculation unit that calculates a radio parameter of radio communication of each base station to reflect the priority indicated by the priority information, a wired parameter calculation unit that calculates, for each wired communication route specified by the route information, a wired parameter of wired communication of a corresponding base station based on the radio parameter calculated by the radio parameter calculation unit to reflect the priority indicated by the priority information, and a setting unit that sets the radio parameter calculated by the radio parameter calculation unit for each base station and sets the wired parameter calculated by the wired parameter calculation unit for each wired communication route.

### TECHNICAL FIELD

The present disclosure relates to a control station, a radio communication system, a communication control method and a communication control program.

### BACKGROUND ART

Examples of radio communication systems using radio waves in the 2.4 GHz and 5 GHz band include those based on the IEEE 802.11a standard and IEEE 802.11g standard. Here, characteristics of the communication systems in multipath fading environments can be stabilized by using the modulation scheme of orthogonal frequency division multiplexing (OFDM), and thus a maximum transmission rate of 54 Mbit/s can be achieved.

In addition, in a radio communication system based on the IEEE 802.11n standard, a multiple-input multiple-output (MIMO) scheme in which a plurality of antennas are used to perform space division multiplexing on an identical radio channel and a channel bonding technique in which two 20 MHz frequency channels are simultaneously used as a 40 MHz frequency channel are used in the 2.4 GHz or 5 GHz band, and thus a maximum transmission rate of 600 Mbit/s can be achieved.

Further, in a radio communication system based on the IEEE 802.11ac standard, a channel bonding technique in which eight 20 MHz frequency channels are simultaneously used as a 160 MHz frequency channel at maximum, a multi-user MIMO technique in which different signals are simultaneously transmitted to a plurality of destinations on the same radio channel, and the like are used in the 5 GHz band to achieve faster and more efficient radio communication compared to that based on the IEEE 802.11n standard (e.g., see NPL 1).

In addition, the base station is connected to a network accommodating device, for example, a router through a backhaul line. The network accommodating device is connected to a line such as the Internet to allow users to perform end-to-end communication.

### CITATION LIST

### Non Patent Literature

NPL 1: IEEE Standard for Information Technology—Telecommunications and Information Exchange between Systems Local and Metropolitan Area Networks-Specific Requirements, Part 11: Wireless LAN Medium Access Control (MAC) and Physical Layer (PHY) Specifications, IEEE Std 802.11-2016, December 2016.

### SUMMARY OF THE INVENTION

### Technical Problem

Examples of a method for controlling a radio communication system include a method in which radio communication performed by a specific base station among a plurality of base stations is prioritized over radio communication performed by other base stations in order to increase throughput in a specific area and deal with congestion of users.

However, in the environment in which the radio communication systems are practically used, no matter how much the communication speed of radio communication is increased, the communication speed of the backhaul line accommodating the base station, the succeeding Internet line, or the like becomes a bottleneck, which may prevent sufficient throughput of the end-to-end communication.

An object of the present disclosure is to provide a control station, a radio communication system, a communication control method, and a communication control program that can more reliably increase the throughput of end-to-end communication in a specific area than in other areas.

### Means for Solving the Problem

A control station according to an aspect of the present disclosure is a control station that controls a plurality of base stations through wired communication on different routes, each base station performing radio communication with a terminal station, the control station including a collection unit that collects priority information indicating priority of radio communication set for each base station and route information for specifying a wired communication route for each base station, a radio parameter calculation unit that calculates a radio parameter of radio communication of each base station to reflect the priority indicated by the priority information, a wired parameter calculation unit that calculates, for each wired communication route specified by the route information, a wired parameter of wired communication of a corresponding one of the plurality of base stations based on at least one of the priority indicated by the priority information or the radio parameter calculated by the radio parameter calculation unit to reflect the priority indicated by the priority information, and a setting unit that sets the radio parameter calculated by the radio parameter calculation unit for each base station and sets the wired parameter calculated by the wired parameter calculation unit for each wired communication route.

In addition, a radio communication system according to an aspect of the present disclosure is a radio communication system including a plurality of base stations and a control station, each base station performing radio communication with a terminal station, the control station controlling each base station through wired communication on different routes, the radio communication system including a collection unit that collects priority information indicating priority of radio communication set for each base station and route information for specifying a wired communication route for each base station, a radio parameter calculation unit that calculates a radio parameter of radio communication of each base station to reflect the priority indicated by the priority information, a wired parameter calculation unit that calculates, for each wired communication route specified by the route information, a wired parameter of wired communication of a corresponding one of the plurality of base stations based on at least one of the priority indicated by the priority information or the radio parameter calculated by the radio parameter calculation unit to reflect the priority indicated by the priority information, and a setting unit that sets the radio parameter calculated by the radio parameter calculation unit for each base station and sets the wired parameter calculated by the wired parameter calculation unit for each wired communication route.

In addition, a communication control method according to an aspect of the present disclosure is a communication control method of controlling a plurality of base stations through wired communication on different routes, each base station performing radio communication with a terminal station, the communication control method including collecting priority information indicating priority of radio communication set for each base station and route information for specifying a wired communication route for each base station, calculating a radio parameter of radio communication of each base station to reflect the priority indicated by the priority information, calculating, for each wired communication route specified by the route information, a wired parameter of wired communication of a corresponding one of the plurality of base stations based on at least one of the priority indicated by the priority information or the calculated radio parameter to reflect the priority indicated by the priority information, and setting the calculated radio parameter for each base station and setting the calculated wired parameter for each wired communication route.

### Effects of the Invention

According to the present disclosure, the throughput of end-to-end communication in a specific area can be more reliably increased than in other areas.

### BRIEF DESCRIPTION OF DRAWINGS

FIG. 1 is a diagram illustrating an exemplary configuration of a radio communication system according to an embodiment.

FIG. 2 is a functional block diagram illustrating functions of a control station according to an embodiment.

FIG. 3 is a diagram illustrating route information collected by a collection unit.

FIG. 4 is a diagram illustrating radio parameters calculated by a radio parameter calculation unit.

FIG. 5 is a diagram illustrating wired parameters calculated by a wired parameter calculation unit.

FIG. 6 is a flowchart illustrating an overview of an exemplary operation of the control station according to an embodiment.

FIG. 7 is a diagram illustrating an exemplary hardware configuration of the control station according to an embodiment.

### DESCRIPTION OF EMBODIMENTS

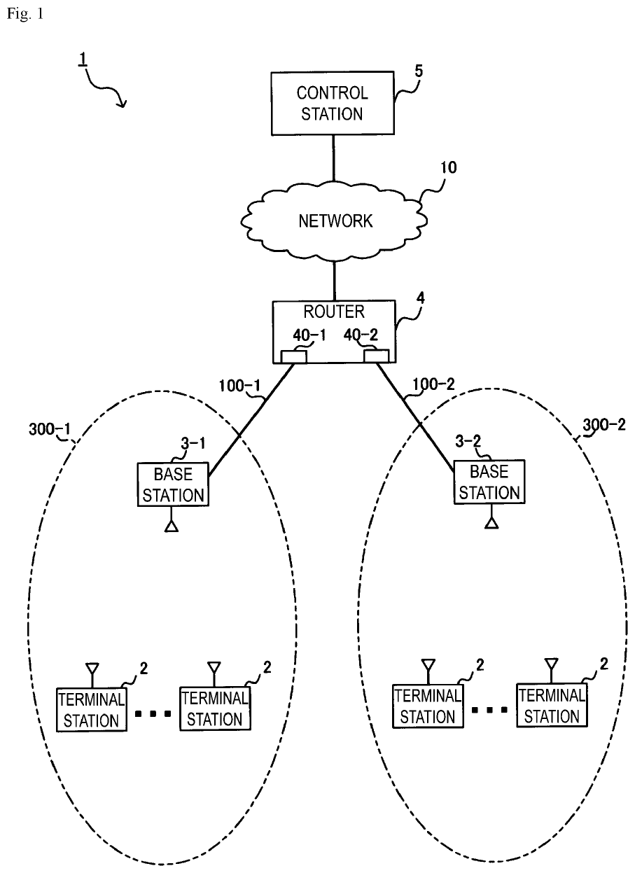

Hereinafter, an embodiment of a radio communication system will be described with reference to the accompanying drawings. FIG. 1 is a diagram illustrating an exemplary configuration of a radio communication system 1 according to an embodiment. As illustrated in FIG. 1, the radio communication system 1 includes, for example, base stations 3-1 and 3-2 to which terminal stations 2 can be connected through radio communication, a router (a network device) 4, and a control station 5. Further, unless any of a plurality of constituent components such as the base stations 3-1 and 3-2 is specified, they will be abbreviated simply as, for example, a base station 3.

The base station 3-1 performs radio communication with the terminal stations 2 located in a cell 300-1. The cell 300-1 is an area in which the base station 3-1 can perform radio communication. In addition, the base station 3-1 is connected to a port 40-1 provided in the router 4 via a wired communication path 100-1 such as an optical cable.

The base station 3-2 performs radio communication with the terminal stations 2 located in a cell 300-2. The cell 300-2 is an area in which the base station 3-2 can perform radio communication. In addition, the base station 3-2 is connected to a port 40-2 provided in the router 4 via a wired communication path 100-2 such as an optical cable.

The router 4 is connected to the control station 5 via a network 10. In other words, the base stations 3-1 and 3-2 are connected to the control station 5 through the wired communication paths on different routes, respectively. In addition, the control station 5 controls each of the base stations 3-1 and 3-2 through wired communication performed on the different routes.

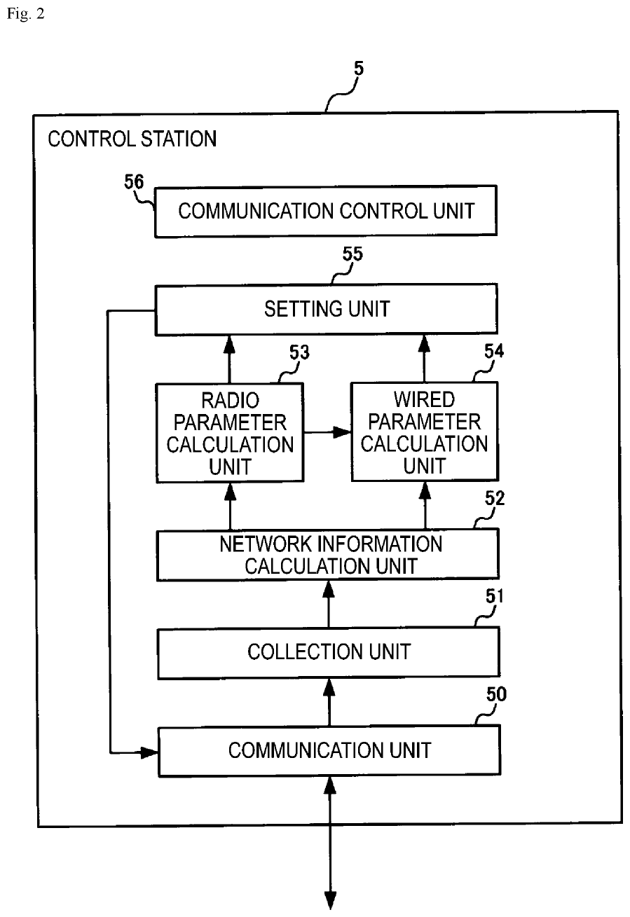

FIG. 2 is a functional block diagram illustrating functions of the control station 5 according to an embodiment. The control station 5 includes a communication unit 50, a collection unit 51, a network information calculation unit 52, a radio parameter calculation unit 53, a wired parameter calculation unit 54, a setting unit 55, and a communication control unit 56 as illustrated in FIG. 2.

The communication unit 50 performs bi-directional wired communication with each of the base stations 3-1 and 3-2 via, for example, the network 10 and the router 4.

The collection unit 51 collects priority information indicating the priority of radio communication that is set for each of the base stations 3-1 and 3-2 from each of the base stations 3-1 and 3-2 via the communication unit 50, and outputs the priority information to the network information calculation unit 52. Here, for example, it is assumed that the priority (i.e., throughput) of radio communication of the base station 3-1 has already been set to be higher than the priority of radio communication of the base station 3-2.

Further, the priority indicated by the priority information may be set to improve the communication efficiency of the entire radio communication system 1 according to a communication amount (such as traffic and session) of radio communication performed by each of the base stations 3-1 and 3-2 with a plurality of terminal stations 2.

In addition, the collection unit 51 collects route information for specifying the route of wired communication for each of the base stations 3-1 and 3-2 from the router 4 via the communication unit 50 and outputs the route information to the network information calculation unit 52.

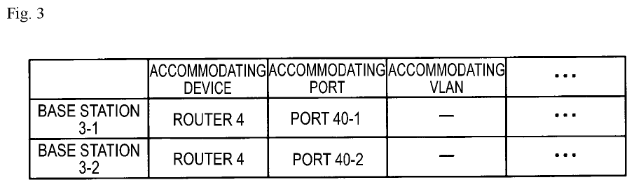

FIG. 3 is a diagram illustrating route information collected by the collection unit 51. As illustrated in FIG. 3, The route information includes information indicating an accommodating device, an accommodating port, and an accommodating virtual local area network (VLAN) for accommodating each of the base stations 3-1 and 3-2. Furthermore, the collection unit 51 collects communication quality information indicating the current communication quality from the base stations 3-1 and 3-2 and the router 4 via the communication unit 50.

The network information calculation unit 52 (FIG. 2) calculates information on the network in the radio communication system 1 using the priority information and the route information collected by the collection unit 51, and outputs the calculated information to the radio parameter calculation unit 53 and the wired parameter calculation unit 54.

The radio parameter calculation unit 53 calculates a radio parameter for radio communication of each of the base stations 3-1 and 3-2 to reflect the priority indicated by the above-described priority information, and outputs the calculated radio parameters to the wired parameter calculation unit 54 and the setting unit 55.

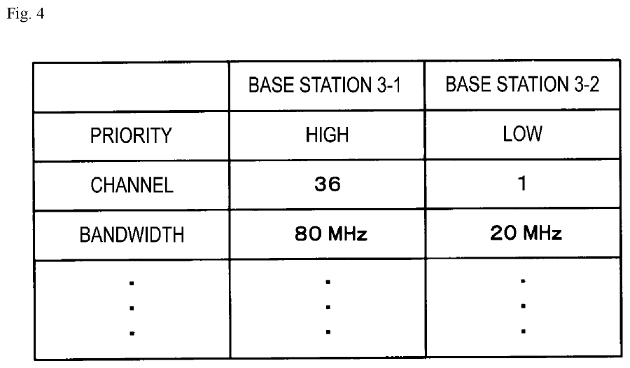

FIG. 4 is a diagram illustrating radio parameters calculated by the radio parameter calculation unit 53. As illustrated in FIG. 4, the radio parameters are parameters for setting, for example, priority, channel, bandwidth, and the like for each of the base stations 3-1 and 3-2.

The wired parameter calculation unit 54 calculates, for each route of the wired communication specified by the above-described route information, a wired parameter of wired communication of a corresponding one of the base stations 3-1 and 3-2 based on at least one of the priority indicated by the above-described priority information or the radio parameters calculated by the radio parameter calculation unit 53 to reflect the priority indicated by the priority information and outputs the wired parameter to the setting unit 55.

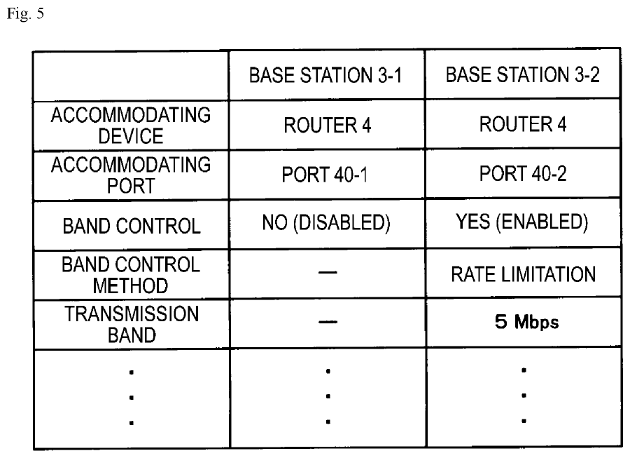

FIG. 5 is a diagram illustrating wired parameters calculated by the wired parameter calculation unit 54. The wired parameters are parameters for setting an accommodating device and an accommodating port (such as route information), as well as the presence/absence of band control on the wired communication route, a band control method, a transmission band, and the like, for each of the base stations 3-1 and 3-2 as illustrated in FIG. 5.

In other words, the wired parameter calculation unit 54 calculates the wired parameters for the wired communication route connected to each of the base stations 3-1 and 3-2. Further, the wired parameter calculation unit 54 may calculate the wired parameters for each protocol or application provided by each of the base stations 3-1 and 3-2.

The setting unit 55 sets the radio parameters calculated by the radio parameter calculation unit 53 for each of the base stations 3-1 and 3-2 via the communication unit 50. In addition, the setting unit 55 sets, for each wired communication route, the wired parameters calculated by the wired parameter calculation unit 54 via the communication unit 50. For example, the setting unit 55 sets the wired parameters of each of the wired communication paths 100-1 and 100-2 for the router 4.

The communication control unit 56 controls each unit constituting the control station 5. In addition, the communication control unit 56 acquires communication quality information from the base stations 3-1 and 3-2 and the router 4 via the communication unit 50 and the collection unit 51, and checks the end-to-end communication quality of the radio communication system 1.

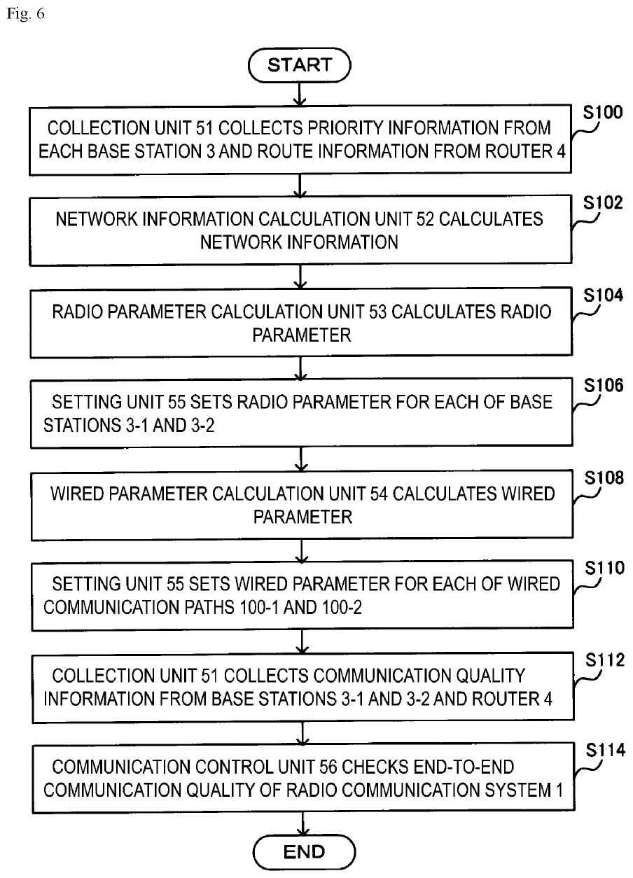

FIG. 6 is a flowchart illustrating an overview of an exemplary operation of the control station 5 according to an embodiment. The collection unit 51 of the control station 5 collects priority information from each of the base stations 3 and collects route information from the router 4 (S100) as illustrated in FIG. 6. The network information calculation unit 52 calculates network information using the priority information and the route information collected by the collection unit 51 (S102).

The radio parameter calculation unit 53 calculates radio parameters for radio communication of each of the base stations 3-1 and 3-2 to reflect the priority indicated by the priority information (S104). The setting unit 55 sets the radio parameters calculated by the radio parameter calculation unit 53 for the base stations 3-1 and 3-2 (S106).

The wired parameter calculation unit 54 calculates, for each wired communication route specified by the route information, wired parameters for wired communication of a corresponding one of the base stations 3-1 and 3-2 (S108). The setting unit 55 sets the wired parameters for the wired communication paths 100-1 and 100-2 (S110).

The collection unit 51 collects communication quality information from the base stations 3-1 and 3-2 and the router 4 (S112). The communication control unit 56 checks the end-to-end communication quality of the radio communication system 1 (S114).

The radio communication system 1 calculates and sets the radio parameters and wired parameters to reflect the priority indicated by the priority information as described above, so that the throughput of the end-to-end communication in the specific area can be more reliably increased than in other areas.

Further, in the radio communication system 1, the priority indicated by the priority information may be set to multiple levels, rather than being limited to two levels of high and low.

Further, some or all of the functions of the base stations 3, the router 4, and the control station 5 may be configured by hardware such as a programmable logic device (PLD) or a field programmable gate array (FPGA), or by a program executed by a processor such as a CPU.

The control station 5 according to the present disclosure can also be achieved by, for example, a computer and a program, and the program can be recorded in a storage medium or can be provided through a network.

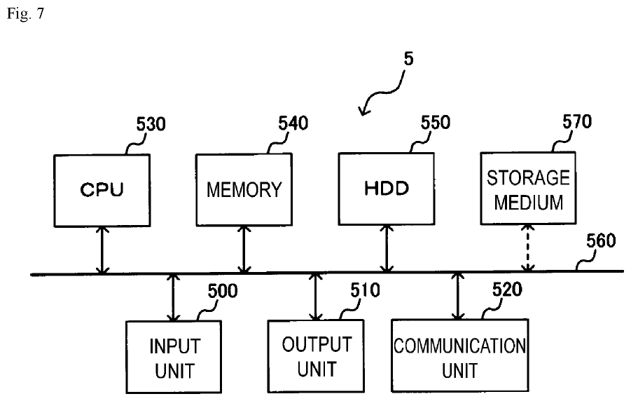

FIG. 7 is a diagram illustrating an exemplary hardware configuration of the control station 5 according to an embodiment. As illustrated in FIG. 7, the control station 5 has, for example, an input unit 500, an output unit 510, a communication unit 520, a CPU 530, a memory 540, and an HDD 550 connected via a bus 560, and functions as a computer. In addition, the control station 5 is designed to be capable of exchanging data with a computer-readable storage medium 570.

Examples of the input unit 500 include a keyboard and a mouse. Examples of the output unit 510 include a display device such as a display. Examples of the communication unit 520 include a wired network interface.

The CPU 530 controls each unit constituting the control station 5 and performs predetermined processing and the like. The memory 540 and the HDD 550 constitute a storage unit that stores data. In particular, the memory 540 stores data to be used in the above-described processing. The storage medium 570 is designed to be capable of storing a communication control program that enables the functions of the control station 5 to be performed, and the like. Further, the architecture of the control station 5 is not limited to the example illustrated in FIG. 7.

In other words, the “computer” mentioned here is assumed to include an OS and hardware such as a peripheral device. In addition, the “computer-readable storage medium” refers to a storage device such as a portable medium such as a flexible disk, a magneto-optical disc, a ROM, and a CD-ROM.

Moreover, the “computer-readable storage medium” may include a recording medium that dynamically holds a program for a short period of time, such as a communication line in a case in which the program is transmitted via a network such as the Internet or a telephone line, or a recording medium that holds the program for a specific period of time, such as a volatile memory inside a computer that serves as a server or a client in that case.

Although the embodiments of the present disclosure have been described above with reference to the drawings, it is apparent that the embodiment described above is a mere example of the present disclosure, and the present disclosure is not limited to the embodiment described above. Thus, addition, omission, substitution, and other modifications of the constituent components may be made without departing from the technical spirit and scope of the present disclosure.

### REFERENCE SIGNS LIST

1 Radio communication system
2 Terminal station
3,3-1,3-2 Base station
4 Router
5 Control station
10 Network
40-1,40-2 Port
50 Communication unit
51 Collection unit
52 Network information calculation unit
53 Radio parameter calculation unit
54 Wired parameter calculation unit
55 Setting unit
56 Communication control unit
100-1,100-2 Wired communication path
300-1,300-2 Cell
500 Input unit
510 Output unit
520 Communication unit
530 CPU
540 Memory
550 HDD
560 Bus
570 Storage medium

1. A control station configured to control a plurality of base stations through wired communication on different routes, each base station being configured to perform radio communication with a terminal station, the control station comprising:
a processor; and
a storage medium having computer program instructions stored thereon, when executed by the processor, perform to:
collect priority information indicating priority of radio communication set for each base station and route information for specifying a wired communication route for each base station;
calculate a radio parameter of radio communication of each base station to reflect the priority indicated by the priority information;
calculate, for each wired communication route specified by the route information, a wired parameter of wired communication of a corresponding one of the plurality of base stations based on at least one of the priority indicated by the priority information or the radio parameter to reflect the priority indicated by the priority information; and
set the radio parameter for each base station and to set the wired parameter for each wired communication route.

2. The control station according to claim 1, wherein
the priority indicated by the priority information is set in advance or set in accordance with a communication amount of radio communication performed by each base station with the terminal station.

3. The control station according to claim 1, wherein the computer program instructions further perform to
calculates a wired parameter for an individual protocol or an individual application provided by each base station.

4. A radio communication system including a plurality of base stations and a control station, each base station being configured to perform radio communication with a terminal station, the control station being configured to control each base station through wired communication on different routes, the radio communication system comprising:
a collection unit configured to collect priority information indicating priority of radio communication set for each base station and route information for specifying a wired communication route for each base station;
a radio parameter calculation unit configured to calculate a radio parameter of radio communication of each base station to reflect the priority indicated by the priority information;
a wired parameter calculation unit configured to calculate, for each wired communication route specified by the route information, a wired parameter of wired communication of a corresponding one of the plurality of base stations based on at least one of the priority indicated by the priority information or the radio parameter calculated by the radio parameter calculation unit to reflect the priority indicated by the priority information; and
a setting unit configured to set the radio parameter calculated by the radio parameter calculation unit for each base station and to set the wired parameter calculated by the wired parameter calculation unit for each wired communication route.

5. The radio communication system according to claim 4, wherein
the priority indicated by the priority information is set in advance or set in accordance with a communication amount of radio communication performed by each base station with the terminal station.

6. The radio communication system according to claim 4, wherein
the wired parameter calculation unit calculates a wired parameter for an individual protocol or an individual application provided by each base station.

7. A communication control method of controlling a plurality of base stations through wired communication on different routes, each base station being configured to perform radio communication with a terminal station, the communication control method comprising:
collecting priority information indicating priority of radio communication set for each base station and route information for specifying a wired communication route for each base station;
calculating a radio parameter of radio communication of each base station to reflect the priority indicated by the priority information;
calculating, for each wired communication route specified by the route information, a wired parameter of wired communication of a corresponding one of the plurality of base stations based on at least one of the priority indicated by the priority information or the calculated radio parameter to reflect the priority indicated by the priority information; and
setting the calculated radio parameter for each base station and setting the calculated wired parameter for each wired communication route.

8. (canceled)
